(19) United States
(12) Patent Application Publication
(10) Pub. No.: US 2011/0200688 A1
(43) Pub. Date: Aug. 18, 2011

(54) Methods and compositions for the reduction of pathogenic microorganisms from meat and poultry carcasses, trim and offal

(76) Inventors: Michael S. Harvey, Modesto, CA (US); Jonathan N. Howarth, Modesto, CA (US); Courtney E. Mesrobian, Modesto, CA (US)

(21) Appl. No.: 12/658,916

(22) Filed: Feb. 16, 2010

(51) Int. Cl. A01N 59/00; A01P 1/00; C11D 3/04

(52) U.S. Cl. 424/723; 510/218; 510/234

(57) ABSTRACT

The invention includes a method of preparing hypobromous acid by mixing an aqueous solution of hydrogen bromide and a source of hypochlorite with water. The invention also includes a method of using the hypobromous acid prepared by this method to wash animal carcasses, trim, and offal to reduce microorganisms, in particular, human pathogenic bacteria, on and in the carcasses, trim, or offal. Compositions of hypobromous acid are also described. The hypobromous acid of the invention may also be used to reduce fat, oil, and grease build-up on equipment and hard surfaces used in the processing of animal carcasses, trim, and offal.

### BACKGROUND OF THE INVENTION

1. Field of the Invention

The invention relates to methods and compositions for reducing pathogenic microorganisms on meat and poultry carcasses, trim, and offal.

2. Description of the Related Art

The contamination of food products by pathogenic organisms such as E. coli O157:H7 and Salmonella typhimurium is an on-going problem that is addressed within the processing plant using antimicrobial chemicals. The efficacy of these Food Contact Substances (FCS) is important to assure a safe and reliable food supply. Meat and poultry processing facilities are adopting new and improved chemical intervention steps of treating their meat carcasses, trim and offal with Food and Drug Administration (FDA) approved sanitizers as part of their (Hazard Analysis and Critical Control Point) HACCP programs. E. coli O157:117 is the primary pathogen of interest in most beef processing plants. It is of particular concern when the facility produces ground beef. During the grinding process, the presence of just a small amount of fecal contamination can spread throughout the entire batch and many thousands of E. coli O157:H7-infested hamburgers can enter the human food chain.

Salmonella typhimurium is more prevalent in poultry processing facilities. Here the concern is that the chicken harbors the bacteria all the way through the processing and packaging operations and the infected bird enters the consumer's kitchen. When the package is opened the chicken is placed on a food preparation surface prior to cooking. Water contaminated with Salmonella bacteria exudes from the bird and onto the food preparation surface. If the area is not cleaned and decontaminated before being used to prepare salad, for example, the salad will become contaminated with Salmonella bacteria that the consumer then ingests.

It can be seen in Table 1 that ingestion of 100 to 1,000,000,000 bacteria cells can induce salmonellosis, and as little as 10 to 100 CFU/ml (Colony Forming Units/milliliter) E. coli O157:H7 bacteria cells can cause hemorrhagic colitis.

TABLE 1
Estimated infectious dose of bacteria species

| | Estimated infectious dose | |
|---|---|---|
| Bacteria Species | (bacteria cell number) | Disease |
| E. coli O157: H7 | 10 to 100 | Hemorrhagic colitis |
| Salmonella | 100 to 1,000,000,000 | Salmonellosis |

Principal source: Foodborne Pathogens: Risks and Consequences, Report No. 122, CAST- Council for Agricultural Science and Technology, September 1994.

Bolder, N. M., Decontamination of Meat and Poultry Carcasses, Trends in Food Science & Technology, July 1997, Vol. 8, reviewed the commonly practiced chemical and physical methods of decontamination of meat and poultry carcasses using washes, rinses, dips, and sprays of chemicals applied to the carcass surfaces. The chemicals method fell into two main categories: oxidizing biocides and non-oxidizing biocides. The oxidizing biocides included chlorine from sodium hypochlorite bleach, chlorine dioxide, hydrogen peroxide and ozone. The non-oxidizing biocides included organic acids, inorganic phosphates and organic preservatives. A subsequent review by Del Rio, E., et. al Effectiveness of Trisodium Phosphate, Acidified Sodium Chlorite, Citric Acid, and Peroxyacids against Pathogenic Bacteria on Poultry during Refrigerated Storage, Journal of Food Protection, Vol. 70, No. 9, 2007, Pages 2063-2071 compared the performance of the most common chemical intervention practices used in poultry processing: trisodium phosphate, acidified sodium chlorite and peroxyacetic acid.

Due to its relatively low cost, sodium hypochlorite bleach is also commonly added to sprays and poultry chill tank water, which chills the birds just prior to packaging. Typically sufficient bleach is introduced so that a level of 50 ppm as Cl₂ is maintained in the chill tank water. Poultry carcasses introduce high levels of ammonia and organic nitrogen to the chill tank water. These compromise the effectiveness of sodium hypochlorite as they binds the chlorine up as chloramines and N-chlorinated compounds which are not as effective against bacteria as free chlorine. A further disadvantage of sodium hypochlorite is that chloramines are volatile and powerful lachrymators causing discomfort to plant workers in the immediate vicinity of the chill tank. They are also highly corrosive to stainless steel structures and equipment.

U.S. Pat. No. 6,986,910 overcame many of the limitations of sodium hypochlorite bleach and disclosed the use of a solid bromine product, 1,3-dibromo-5,5-dimethylhydantoin (DBDMH) as a method of controlling microbial contamination in poultry chill tanks. Unlike chlorine, bromine is not compromised by ammonia and organic nitrogen. The resulting bromamines are well known to retain their biocidal efficacy. Unlike chloramines, bromamines have low persistency in water and decompose before volatilizing into the atmosphere. Consequently, plant workers in the vicinity of the chill tanks are unaffected by airborne lachrymators, and vapor phase corrosion of stainless steel structures and equipment is reduced.

The same chemical, and a related one, N,N′-bromochloro-5,5-dimethylhydantoin (BCDMH), were subsequently disclosed for use in reducing the microbial contamination on the carcasses of four-legged animals (U.S. patent application publication no. 2007/0141974; WO 2006/071224).

DBDMH and BCDMH are sparingly water-soluble solids. Tablets or granules of the solids are manually loaded into chemical feeders through which water flows. The chemicals slowly dissolve and halogen is introduced to the water exiting the feeder. This water is added to the water requiring biocidal treatment e.g. the chicken chill tank or animal carcass wash water. The sparingly soluble nature of the materials is a major limitation for several reasons.

First, poor management of water is a significant limitation. This is because large volumes of water must be passed through the feeder in order to dissolve sufficient product to adequately treat the receiving water (the water requiring treatment). In extreme cases, the volume of water may be so large that the receiving water is not able to accommodate it. In such cases, the receiving water may be underdosed with biocide, or the receiving water may overflow its containment and be lost as waste.

A second drawback is the inconsistency of accurate dosing. This is because the amount of halogen introduced to the water flowing through the chemical feeder is a function of the bed height of the solids that are in the feeder. When the feeder is full, the water contacts the entire bed of product to maximize the amount of halogen that dissolves. As the solid dissolves, the bed height is lowered and so with less product to contact, the water exiting the feeder receives a lower dose of halogen. The solubility of a solid is also a function of temperature and more halogen will dissolve into warm water than it will into cold water. Thus with seasonal changes in temperature, the amount of halogen that dissolves in the water flowing through the feeder fluctuates.

Howarth, et.al, in U.S. Pat. Nos. 5,641,520 and 5,422,126 sought to overcome the deficiencies of using chemical feeders to dissolve sparingly soluble dihalogenated hydantoin solids and disclosed a batch method for preparing solutions of the more soluble monobrominated hydantoin (MBDMH). The use of DMH was necessary as solutions of HOBr without DMH were considered to be too unstable to be of practical use. Howarth disclosed the use of MBDMH solutions for low level dosing of bromine for treatment of cooling water, recreational water, pulp and paper mill whitewater and municipal wastewater. Howarth taught a batch process in which hydrogen bromide solution was reacted with sodium hypochlorite solution to generate HOBr, but did not disclose a continuous process. Howarth demonstrated that the HOBr solutions prepared using a batch process were too unstable for practical use and therefore required the addition of 5,5-dimethylhydantoin (DMH) as a stabilizer that reacted with the HOBr to form the more stable MBDMH complex. Howarth added hydrobromic acid solution to the entire body of water followed by the addition of sodium hypochlorite solution and DMH. Howarth also demonstrated the formation of MBDMH by using stoichiometric (1:1 mole ratio) amounts of HOBr and DMH. If lower than a 1:1 mole ratio of HOBr:DMH was employed, DBDMH precipitated from solution and the aqueous phase lost activity.

A third limitation is the compromised efficacy when recycled water is treated. This is because, in meat and poultry processing, DBDMH and other halogenated hydantoins have been found to be only efficacious for treating once-through, non-recycled water such as the carcass wash, the off-line reprocessing wash, the inside-outside bird wash, pre and post chiller rinses, and trim and offal spray bars. The halogenated hydantoins have been found to be much less efficacious in recycled water systems such as the poultry chill tank. Here, a solution of DBDMH is introduced to the water used to cool the chickens just prior to packaging. Typically, the water is recirculated and continuously dosed with additional quantities of dissolved DBDMH to make up for halogen that is consumed by chemical demand reactions and the disinfection process. The reaction products include bromide ion and DMH. Whilst not wishing to be bound by theory, it is believed the compromised efficacy in recycled water is the result of overstabilization of the halogen due to accumulation of DMH.

For example, it is known that DBDMH, MBDMH and BCDMH hydrolyze in water to release their respective hypohalous acids:

DBDMH+2H₂O=DMH+2HOBr

MBDMH+H₂O=DMH+HOBr

BCDMH+2H₂O=DMH+HOBr+HOCl

Thus, water treated with either BCDMH, MBDMH or DBDMH always contain residual DMH. In fact, it is well known that DMH and hypohalous acids remain closely associated with each other in solution, as DMH confers stabilizing properties to the halogens via complex formation (U.S. Pat. No. 6,086,746). When the treated water is recycled, and continuously dosed with any of the above three halogenated hydantoins, DMH accumulates and the complexation with the hypohalous acids is reinforced. When this occurs the microbiocidal efficacy of the hypohalous acids is compromised because the halogen is overstabilized.

Therefore, there exists a need for a method that overcomes the deficiencies of feeding solid dihalogenated hydantoins, and liquid monobromohydantoins for biocontrol of water used to treat animal carcasses, trim and offal. There is an additional need for a bromine-based system that is not microbiologically compromised by accumulation of DMH so that the water can be recycled and dosed continuously.

During the processing of animal carcasses, the meat products move between the various processing stations via conveyor belts. Over the course of a shift, layers of fat, oil, and grease can accumulate on the belts as well as on other equipment and the floor. On floors these layers represent a slipping hazard to employees whereas on food contact surfaces the layers represent a safe harbor for potentially dangerous microorganisms. Therefore, at the end of a shift, the equipment is chemically cleaned of the layers of fat, oil and grease to ready it for the next shift. Fat is removed by saponification using highly alkaline chemicals which can be expensive and hazardous. Oil and grease are removed by emulsification with synthetic surfactants. These cleaning processes require significant time, which reduces the production capacity of the plant. Thus, there is a need for a more efficient and effective method of removing fat, oil, and grease.

### SUMMARY OF THE INVENTION

This invention addresses the above-discussed needs with the discovery of an inexpensive and efficient continuous process for making solutions of HOBr that are suitable for contacting animal carcasses, trim and offal. Moreover, contrary to the teachings of the prior art, the solutions of HOBr are of surprisingly sufficient stability to be made, stored and used several hours or even days later.

In one embodiment, the invention is a method for continuously preparing an aqueous solution of hypobromous acid (HOBr) by mixing in water an aqueous solution of hydrogen bromide (HBr) (i.e., hydrobromic acid) with a 1:1 stoichiometric amount of a source of hypochlorite (i.e., each mole of HBr is mixed with one mole of hypochlorite ion from a source of hypochlorite).

A second embodiment is a method of using the resultant HOBr solution to contact an animal carcass, animal trim, or animal offal for sufficient time to effect a reduction in the number of microorganisms, including human pathogenic bacteria, associated with the carcass, trim, or offal.

Yet another embodiment is a composition made by the method of the first embodiment in which the concentration of HOBr is greater than 20,000 ppm and less than 30,000 ppm (as bromine or Br₂).

The antimicrobial solutions prepared by the method of the current invention are near pH neutral, and contain no surfactants. Nevertheless, these solutions have been found to exhibit surprising and remarkable fat, oil, and grease solubilization properties. Not only do these solutions have the advantages of reducing cleaning chemicals and clean-up times, but they are also effective against microorganisms concomitant in the fat, oil and grease layers that accumulate on conveyor belts and other food contact surfaces.

Another embodiment is a method of reducing the build-up of fat, oil, and grease on food contact and equipment surfaces, and hard surfaces, such as floors, used in the processing of animal carcasses, trim, and offal.

### BRIEF DESCRIPTION OF THE DRAWINGS

FIG. 1 is a schematic representation of a system used to continuously prepare a solution of hypobromous acid (HOBr) in a controlled manner according to the method of the invention.

FIG. 2 is a graph showing the decay of HOBr from DBDMH compared to HOBR from NaOCl—activated HBr solution (600 ppm as bromine).

FIG. 3 is a graph showing the stability profile of hypobromous acid as bromine.

FIG. 4 is a graph showing the pH over time of HOBr solutions.

### DETAILED DESCRIPTION OF THE INVENTION

I. Analytical Methods Used

In the examples set forth below, references are made to an iodometric titration, a N,N-diethyl-p-phenylenediamine (DPD) Total Halogen Colorimetric Method and a DPD Differentiation Colorimetric Method (also known as the Palin Modification). These methods were used to quantify and/or differentiate halogen levels for the microbiology and storage stability studies, which are now presented. Each method is described in detail below.

A. Iodometric Titration Method

The iodometric titration is a technique that allows for the determination of the total halogen present in any given system and is usually the method of choice when concentrated halogen solutions are prepared. This technique does not allow for the differentiation between the halogens e.g. how much is present as bromine and how much is present as chlorine. Therefore, the halogen levels determined by the iodometric method are usually expressed in terms of “as chlorine” or “as bromine” even though the system may contain a mixture of both bromine and chlorine. A typical iodometric titration is performed as follows:

A sample of the halogen-containing solution is accurately weighed (4 decimal places) to a beaker, then deionized water (DI) or reverse osmosis (RO) water is added to the beaker. Using a magnetic stir bar to ensure appropriate mixing, add approximately 5 ml of 80% acetic acid and approximately 1 g potassium iodide crystals to the beaker. Mix the solution and allow the potassium iodide crystals to dissolve. The solution will turn a dark yellow/red color as the bromine or chlorine or both, oxidize the iodide ion to liberate iodine. Under acidic conditions, aqueous halogen-containing solutions quantitatively liberate iodine from excess potassium iodide. The liberated iodine is titrated with a standard solution of 0.1000N sodium thiosulfate (Na₂S₂O₃) until the solution turns a faint straw color. The faint straw color indicates the titration is near its end-point. Starch indicator (1 ml of 0.5% starch) is then introduced to the titration flask so that the solution changes from pale straw yellow to black or dark blue. This is the color of the complex that forms between starch and iodine. The more intense blue/black color serves to sharpen the end-point. Continue to titrate drop by drop until the blue/black color is completely discharged and the solution is colorless. The volume (V) of 0.1000N sodium thiosulfate titrant required to affect the end-point is used to calculate the activity of the halogen-containing solution.

Calculation:

To express the results as weight % as Cl₂:

$$Wt \% as {Cl}_{2} = \frac{V \text{/} ml \times N {Na}_{2} {S}_{2} {O}_{3} \times 0.03545 \times 100}{Wt . of sample \text{/} g}$$

To express the results as weight % as Br₂:
Calculate the weight % as Cl₂ and multiply the result by 2.25.
Example: 10.2% as Cl₂=10.2×2.25=22.95% as Br₂

B. DPD Total Halogen Colorimetric Method

The DPD Total Halogen Method is similar to the iodometric titration in that it also is limited to detecting the total halogen level in an aqueous system, but is more accurate when low levels of total halogen are present. A typical DPD Total Halogen Method is performed as follows.

A HACH DR/700 Colorimeter (or equivalent) is utilized for the analysis. To analyze the concentration of halogen as total chlorine on the HACH DR/700 Colorimeter, module number 52.01 (525 nm) should be installed and used in conjunction with HACH Method number 52.07.1. The instrument must be set to the low (LO) range mode so that the display reads to the hundredths place (0.00). Make an appropriate dilution with reverse osmosis (RO) or deionized (DI) water. Fill two sample cells with 10 ml of the diluted sample. Designate one of the cells to be the “blank” and the other to be the prepared sample. Dry the outside of both cells with a paper towel or cloth and make sure the cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Total Chlorine pillow pack (for a 10 ml sample volume) to the prepared sample cell. Cap and shake vigorously. A pink color will develop indicating the presence of halogen. Immediately place the sample cell in the compartment with the diamond facing you, cover the cell compartment and press READ. The instrument display will flash “ - - - ” followed by the results in ppm total chlorine.

Calculations:

Total Chlorine: no calculation needed, the instrument reading is the ppm total Cl₂.

Bromine: ppm Br₂=2.25×ppm total Cl₂

(Multiply the result by dilution factor in order to obtain the halogen concentration in the parent (undiluted) solution).

C. DPD Differentiation Colorimetric Method (Also Known as the Palin Modification)

In order to determine how much of the halogen is present as bromine and how much is present as chlorine, the DPD Differentiation Method (also known as the Palin Modification) is utilized. This method allows for the differentiation and quantification of bromine and chlorine in a solution. A typical DPD Differentiation Method is performed as follows.

A HACH DR/700 Colorimeter is utilized for this testing. To analyze the concentration of halogen as free chlorine on the HACH DR/700 Colorimeter, module number 52.01 (525 nm) should be installed and used in conjunction with HACH Method number 52.05.1. The instrument must be set to the low (LO) range mode so that the display reads to the hundredths place (0.00). Make an appropriate dilution. For example, testing a theoretical 300 ppm as Br₂ solution, weigh out 97.0 g distilled water, exactly 1.00 g of solution containing the theoretical 300 ppm as Br₂, and 2.0 g of a 10% glycine solution. The diluted solution is then well mixed in order to bind any free chlorine present into the form a combined form of chlorine, N-chloroglycine. Fill two sample cells with 10 ml of the diluted sample containing the glycine. Designate one of the cells to be the “blank” and the other to be the prepared sample. Dry the outside of both cells off and make sure both cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Free Chlorine pillow pack (for a 10 ml sample size) to the prepared sample. Cap and shake vigorously. A pink color will develop indicating the presence of bromine. Place the sample cell in the compartment with the diamond facing you, close the cover and press READ. The instrument display will flash “ - - - ” followed by the results in expressed in ppm free chlorine. This reading is designated “B.” Remove the sample cell from the compartment and add a small amount of potassium iodide (KI) crystals (2-3 crystals) to the prepared sample cell still containing the sample, and vigorously shake. This step allows any glycine-bound chlorine to react with the KI, liberate iodine, which then reacts with the DPD indicator to intensify the pink coloration. Place the sample cell back in the compartment with the diamond mark facing you, close the cover and press READ. The results represent total halogen expressed as ppm free chlorine. This reading is designated “TH.”

Under conditions when all the halogen is present as bromine, the results from the first and second reading are identical, meaning there was no color intensification when the KI crystals were added to the prepared sample cell: TH=B.

If TH>B, then some of the halogen is present as chlorine (C) expressed as ppm free chlorine: Therefore, C=TH−B.

Calculation:

Bromine: ppm Br₂=2.25×B

(Multiply the result by dilution factor in order to obtain the halogen concentration in the parent (undiluted) solution).

II. Definitions

The following definitions are used in this specification.

“Animal carcasses” means the dead bodies of animals, especially ones slaughtered for food. In this context, carcasses are understood to be the dead bodies of four-legged animals with or without hide such as cattle and hogs and the dead bodies with or without feathers of poultry such as chicken and turkey.

“Meat carcass” means the carcasses of beef, pork, lamb, and any other four-legged animal that is processed for food.

“Poultry” means all birds, including, chicken, turkey, pheasant, squab, and others.

“Trim” means a cut of meat or poultry, such as what is left after primal cuts are removed from the carcass of the butchered animal. These can be the bits trimmed off larger cuts to make them the right size and shape for selling to the consumer and to ensure that they have the correct amount of fat for the grade (Choice, Select, and so on). It primarily includes trimmings off the skeleton. Trim is used to make ground meat and further processed products such as sausage.

“Offal” means the entrails and internal organs of a butchered animal, and generally includes most internal organs other than muscle or bone (e.g., heart, kidneys, tongue, liver, and stomach).

“Primal cut” refers to a piece of meat initially separated from the carcass during butchering. Primal cuts may be sold complete or cut further into smaller sub-primal units

III. Method of Preparing Hypobromous Acid

One embodiment of the invention is a method for continuously preparing an aqueous solution of hypobromous acid (HOBr) by mixing in water an aqueous solution of hydrogen bromide (HBr) (i.e., hydrobromic acid) with an approximately 1:1 stoichiometric amount of a source of hypochlorite (i.e., each mole of HBr is mixed with approximately one mole of hypochlorite ion from a source of hypochlorite).

Any source of an aqueous solution of HBr may be employed. A particularly convenient source of aqueous HBr is that which is a byproduct of organic bromination reactions used to make, for example, brominated flame retardants. During the reaction of elemental bromine with an organic compound such as bisphenol A, a bromine atom substitutes for a hydrogen atom on the aromatic rings and hydrogen bromide gas is evolved from the reactor. Hydrogen bromide gas is extremely soluble in water and so the gas is captured with a water scrubber. On heating the resultant solution, HBr gas is evolved (along with some water) and the solution steadily decreases in strength until it distills unchanged at 126° C. as the constant boiling azeotrope containing 48% HBr. The azeotropic composition may be used directly in the method of the invention or it may be diluted 50:50 w/w with water prior to use to yield a 24% solution of HBr which is safer to ship than 48% HBr and has less tendency to fume corrosive HBr vapors. In addition, the 24% solution of HBr has less tendency to undergo undesirable photochemical formation of bromine during storage.

Another suitable source of an aqueous solution of HBr is that formed when a solution of sodium bromide (NaBr) is mixed with a stoichiometric amount of a strong mineral acid such as hydrochloric acid (HCl), sulfuric acid (H₂SO₄) or nitric acid (HNO₃) (i.e., each mole of bromide ion is mixed with one mole of proton (hydrogen ion) from the mineral acid). In solution, the bromide (Br⁻) ions from NaBr are fully dissociated, as are the protons and anions of a strong mineral acid. Hence a solution of NaBr and a stoichiometric amount of strong mineral acid is indistinguishable from a solution of HBr and the salt of a mineral acid.

Any source of hypochlorite may be employed. It is convenient if the hypochlorite source is commercially available as an aqueous solution such as sodium hypochlorite (NaOCl) or potassium hypochlorite (KOCl). For economic reasons, solutions of NaOCl are preferred. It is well known that solutions of NaOCl are unstable at normal temperatures and degrade with time. However, the invention does not depend on the age or activity of the NaOCl solution. If the solution has degraded below the 12.5% NaOCl concentration that is commonly supplied, then the end user simply has to adjust the NaOCl delivery pump to a faster pumping rate to compensate for the lower concentration of the degraded solution.

Solid sources of hypochlorite are also suitable for use. These include calcium hypochlorite (Ca(OCl)₂) and lithium hypochlorite (LiOCl). For economic reasons, solid Ca(OCl)₂ is preferred and may be administered in the form granules or tablets. Water is flowed through chemical feeder devices containing the solids. Depending upon the water temperature, and the amount of solid product that the water contacts in the feeder, a hypochlorite solution of a well-defined concentration exits the chemical feeder. The actual concentration can be determined by iodometric titration and expressed as weight % as Cl₂. This permits calculation of the HBr solution flow rate required for mixing with the Ca(OCl)₂ solution. In this way, stoichiometric amounts of HBr and Ca(OCl)₂ are continuously delivered to form the HOBr solution (i.e., each mole of HBr is mixed with one mole of hypochlorite ion from a source of hypochlorite).

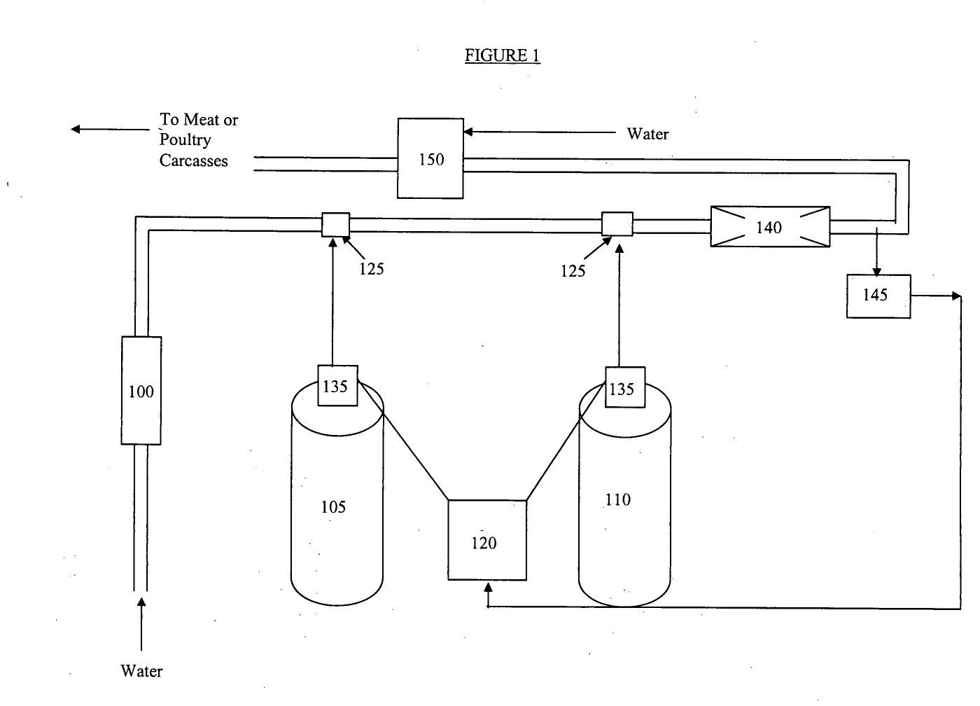

FIG. 1 is a schematic representation of a system used in the method of the invention to continuously prepare a solution of HOBr. A container of aqueous hydrogen bromide solution 105 and a container of a source of hypochlorite, preferably sodium hypochlorite bleach, 110 were each equipped with chemical delivery diaphragm pumps 135. Water was directed through a flowmeter 100 and into a length of pipe where the hydrogen bromide solution was introduced through injection point 125, and sodium hypochlorite solution was introduced through injection point 130. The hydrogen bromide solution and the sodium hypochlorite solution may be added in a sequential manner with either solution first, or they may be added to the water simultaneously through a Tee fitting. In this case, the hydrogen bromide solution and the sodium hypochlorite solution are introduced to the two arms of a Tee fitting and the mixture is injected into the pipe of water. Because the dilution water flow is typically controlled by a solenoid or valve, this method of addition can be either continuous or intermittent depending upon the position of the flow control valve. The water containing hydrogen bromide and sodium hypochlorite solutions was mixed using an in-line static mixer 140. A pH probe and meter 145 monitored the pH of the mixture and adjusted the rate of addition of hydrogen bromide solution or sodium hypochlorite solution through a pH controller 120 that is interfaced to the chemical delivery diaphragm pumps 135. The mixture was then directed to a proportional dispenser 150 set to dilute the mixture to the desired HOBr concentration with water. The degree of dilution depends on the required concentration of HOBr. Instead of proportional dispenser 150 a conventional diaphragm or centrifugal pump may be used to effect the desired dilution provided the volumetric flows rates of the dilution water and activated solution are known.

### EXAMPLES 1-3

The apparatus represented in FIG. 1 was used to continuously generate solutions of HOBr that were close to 300 ppm (as Br₂). The results are shown in Table 2.

TABLE 2
Flow Rates and Dilution Ratios

| | | | | Br₂ | | |
|---|---|---|---|---|---|---|
| | | | | concentration | Dilution | |
| | | 24% HBr | | entering | ratio at | |
| | Water flow through | flow through | 12.5% NaOCl | proportional | proportional | Final Br₂ |
| Example | flowmeter 100 | pump 35 | through pump 35 | dispenser 150/ | dispenser | Concentration/ |
| No. | L/min | ml/min | ml/min | ppm | 150 | ppm |
| 1 | 3.785 | 38.4 | 68.9 | 5865 | 19.6 | 300 |
| 2 | 3.785 | 52.5 | 94.7 | 8050 | 26.8 | 300 |
| 3 | 1.0 | 0.525 | 0.991 | 289 | N/A | 289 |

### EXAMPLE 4

The relative stability of HOBr derived from NaOCl-activated HBr and HOBr derived from DBDMH was compared side-by-side. A solution of HOBr (600 ppm as bromine) was used in the comparison because this is the amount of bromine that typically exits the commercial DBDMH feeders when the solid product is dissolved. The activity of the solutions was measured using the DPD Total chlorine colorimetric method. Solutions were stored in the dark to prevent photodegradation due to UV light exposure. The temperature ranged from 70-75° F. for the duration of the test.

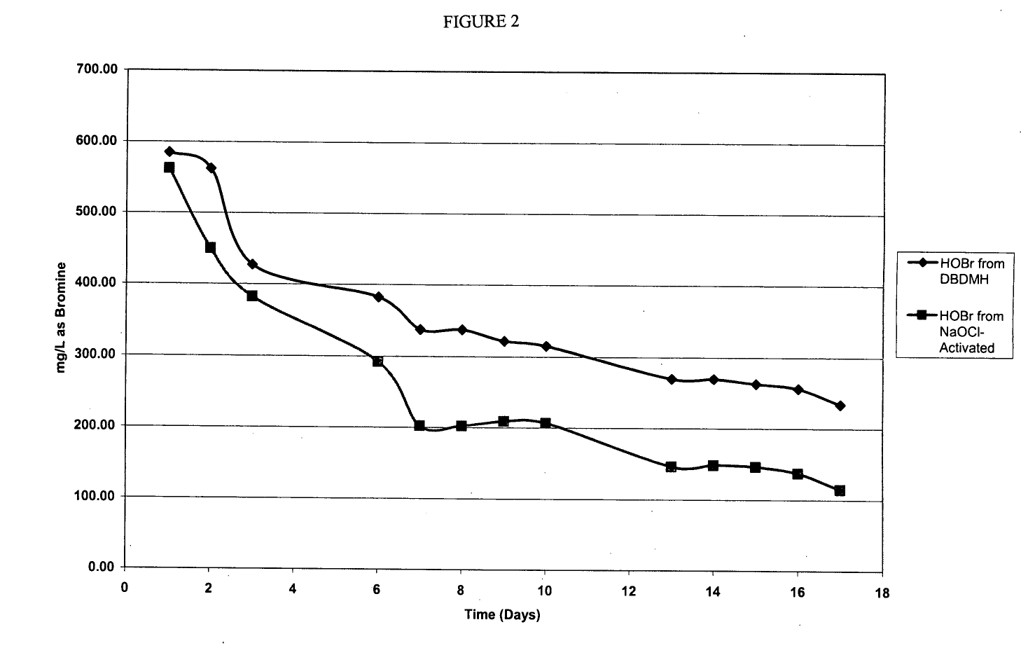

The HOBr decay profiles for the 600 ppm (as bromine) solutions derived from NaOCl-activated HBr solution and DBDMH solution are plotted in FIG. 2.

FIG. 2 demonstrates that the presence of DMH does have a stabilizing effect on the HOBr, but contrary to the teachings of Howarth et. al, it is not an essential requirement for production of a solution which might be stored several days prior to use. The half-lives of the HOBr in the respective solutions are calculated as follows:

Graphs of ln(Co/Ct) where Co is the initial concentration of HOBr and Ct is the concentration at day t were close to straight lines for both the DBDMH and NaOCl-activated HBr derived solutions. (the regression analysis correlation coefficient, R² values were close to 1). The R² value for the DBDMH and the NaOCl-activated HBr solutions were 0.9251 and 0.9302, respectively. The slope for the linear regression line for the NaOCl-activated HBr solution indicated the HOBr decayed with a rate constant of 0.0880 day⁻¹. The slope for the linear regression line for the DBDMH indicated that the HOBr solution decayed with a rate constant of 0.051 day⁻¹.

The half-lives of HOBr from the HBr-activated solution and the DBDMH solution were calculated by dividing the slopes of the respective regression lines by 0.692—the natural logarithm (ln) of 2. These figures are displayed in Table 3 below.

TABLE 3

| Solution | Half-Life |
|---|---|
| NaOCl-activated HBr solution | 7.9 days |
| (600 ppm as bromine) | |
| DBDMH (600 ppm as bromine) | 13.4 days |

### EXAMPLE 5

The previous examples (1-4) demonstrate that solutions of sodium hypochlorite readily activate HBr to HOBr instantaneously and, depending on the final concentration of HOBr, typically with 100% conversion. Thus, it would be expected that all hypochlorite solutions (e.g. potassium hypochlorite (KOCl)), would work in an identical fashion. This example determined the efficiency of the process when solid sources of hypochlorite, such as calcium and lithium hypochlorite, are used to activate HBr. In this example, solid calcium hypochlorite was used to activate HBr to determine the efficiency of bromide ion utilization and the stability of the resultant activated solutions.

In this example, 48% HBr was activated using three different techniques of using solid calcium hypochlorite (70% expressed as Cl₂). Techniques 1 and 2 utilized stoichiometric amounts of 48% HBr and solid calcium hypochlorite (70% as Cl₂) to generate a solution of HOBr (theoretically 5000 ppm expressed as bromine). In technique 1, 48% HBr was introduced to a slurry of calcium hypochlorite in city water. In technique 2, a calcium hypochlorite slurry was introduced to city water containing the 48% HBr. Technique 3 is the same order of addition as technique 2 except the amount of calcium hypochlorite (70% as Cl₂) that was introduced was based solely on the observed color change of dark orange to bright yellow. The relative % conversion of bromide ion into HOBr was assessed for each method, in addition to determining the decay kinetics for each activated solution.

In the first technique, calcium hypochlorite (70% as Cl₂) (3.023 g) was added to the city water (942.0 g) to produce a slurry, because not all the solid components in the calcium hypochlorite were fully solubilized. Using a magnetic stir plate the slurry was mixed gently. While mixing, the 48% HBr (5.00 g) was smoothly added to the slurry within approximately 15 seconds. After all the 48% HBr was added, a clear, solids-free solution was obtained. During the addition, the mixture turned from an initial pale yellow pale color to dark orange then to a bright yellow solution.

In the second technique, the 48% HBr (5.00 g) was introduced to the city water (942.0 g) first. Using a magnetic stir plate the solution was mixed gently. While mixing, the calcium hypochlorite (70% as Cl₂) (3.0224 g) was smoothly added to the solution over the course of 30 seconds. During the addition, the mixture turned from an initial pale yellow color to dark orange and then to a bright yellow solution. No turbidity indicative of undissolved solids was observed throughout the activation process.

In the third technique, the 48% HBr (5.00 g) was introduced to the city water (942.0 g) first. Using a magnetic stir plate the solution was mixed gently. While mixing, calcium hypochlorite (70% as Cl₂) was smoothly added to the solution until the color of the solution changed from pale yellow to dark orange to bright yellow to signal the termination of the calcium hypochlorite addition. The amount of calcium hypochlorite (70% as Cl₂) added at this point was 2.88 g. The calcium hypochlorite (70% as Cl₂) addition took approximately three minutes.

For all three techniques, the activated solutions were stored away from direct UV light to prevent photodegradation during the stability testing. The tests were performed at ambient temperature. The solutions were initially tested using the DPD Differentiation Method (also known as the Palin Modification) to confirm no chlorine was present after activation. After verifying no excess chlorine was present, the solutions were analyzed using the DPD Total Halogen Method. The results were expressed as ppm as bromine. These results were used to determine the percent bromide ion activated to HOBr. Then the decay profiles were used to determine the half-lives and decay rate constants.

Graphs of ln(Co/Ct) (where Co is the initial concentration of HOBr and Ct is the concentration at time t) plotted against time t. The R² values for techniques 1, 2, and 3 each plotted close to a straight line (the regression analysis correlation coefficient, R² value was close to 1) for all three Ca(OCl)₂-activated HBr solutions. The R² values for techniques 1, 2, and 3 were 0.9375, 0.8609, and 0.9528, respectively. From this line the half-lives and rate constants were determined. The half-lives were calculated by dividing the slopes of the respective regression lines by 0.693—the natural logarithm of 2. The slope of the respective linear regression lines indicated the rate constant for HOBr decomposition (expressed as Br₂) at each concentration. These figures are reported in Table 4 below.

TABLE 4

| | Conc. | | % Br⁻ ion | | |
|---|---|---|---|---|---|
| Tech- | (ppm | pH After | Activated | Half- | Rate |
| nique | as Br₂) | Activation | to HOBr | Life | Constant |
| 1 | 4702.5 ppm | 7.41 | 94.24% | 270.6 min | 0.0026 min⁻¹ |
| 2 | 5000 ppm | 7.28 | 100% | 336.6 min | 0.0021 min⁻¹ |
| 3 | 4522.5 ppm | 7.49 | 90.64% | 181.2 min | 0.0038 min⁻¹ |

The solid calcium hypochlorite successfully activated the HBr but subsequently the HOBr generated was not as stable as when HBr was activated with sodium hypochlorite. The percent bromide ion conversion into HOBr is high in all cases. However, compared to similar concentration solutions prepared using aqueous sodium hypochlorite solutions, the calcium hypochlorite-activated solutions degrade more rapidly. It is noteworthy that the least efficient conversion of Br⁻ ion into HOBr and the least stable activated solution was prepared when the color transition method was used to determine the time to terminate the Ca(OCl)₂ addition. This further contrasts the method advocated by Howarth (U.S. Pat. Nos. 5,641,520 and 5,422,126) which stated that the observation of the color transition was the signal to cease the addition of hypochlorite. Consequently, activation of HBr using a stoichiometric amount of solid hypochlorite is the preferred method.

It can thus be concluded that solid sources of hypochlorite such as Ca(OCl)₂ are also suitable for activation of HBr into HOBr. Noting that low conversion of bromide ions to HOBr represents the major chemical cost limitation and hence the economics of the process, and for reasons of improved storage stability, it is preferred that stoichiometric amounts of HBr solution and solid hypochlorite are employed (i.e. each mole of HBr is mixed with one mole of hypochlorite ion from calcium hypochlorite).

### EXAMPLE 6

Another method of forming an aqueous HBr solution is through the combination of sodium bromide and hydrochloric acid. During the first attempt to form a theoretical 24% HBr solution, 46% sodium bromide (40.00 g) was accurately weighed to a beaker. To this, a stoichiometric amount of 31.4% hydrochloric acid (20.78 g) was smoothly added with gentle agitation. However, a precipitation reaction immediately occurred. The precipitate was white and thought to be the formation of solid NaCl salt. To the precipitated sample, sufficient reverse osmosis (RO) water (18.02 g) was added until a homogenous solution was achieved. The theoretical concentration for the diluted solution was 18.36% HBr. The second attempt was to prepare the 18.36% HBr solution directly, and without precipitation by the addition of excess water before the hydrochloric acid was introduced. The preparation of the second sample required a stoichiometric amount of 46% sodium bromide (40.00 g), which was added to RO water (17.6 g) and mixed. Then a stoichiometric amount of hydrochloric acid 31.4% (20.78 g) was added to the sodium bromide and water under gentle agitation. This produced a homogeneous solution equivalent to a theoretical 18.46% HBr. The solution was storedin a clear container with lid and stored at 35-40° F. for two days in the laboratory refrigerator. The sample was determined to have no precipitate after the two days, but a few small crystals formed after a period of 15 days at the depressed temperature.

IV. Method of using Hypobromous Acid to Wash Animal Carcasses, Trim, and Offal

A second embodiment of the invention is a method of using the resultant HOBr solutions to wash an animal carcass, animal trim, or animal offal for sufficient time to reduce the number of microorganisms, including human pathogenic bacteria, associated with the carcass, trim, or offal.

The HOBr solutions prepared using the method of the first embodiment of the invention display antimicrobial properties to microorganisms resident on and within the animal carcass, animal trim, or animal offal. These include spoilage microorganisms such as yeast, mold, and fungi, but the solutions prepared by the method of the invention are especially effective against human pathogenic microorganisms including enteric bacteria such as E. coli O157:H7 and Salmonella typhimurium.

The animal carcasses, animal trim, or animal offal are contacted with the HOBr solutions in any manner that permits good distribution of the HOBr solution over the animal piece. This can be accomplished by dipping or submerging the animal piece in a tank of HOBr solution, subjecting the animal piece to a pressurized spray of HOBr solution, or subjecting the animal piece to a fog of HOBr solution produced by directing the HOBr solution through fogging apparatus. During the dipping, submersion, spraying and fogging, the animal piece may be subject to mechanical action through agitation or by physical scrubbing with brushes. During spraying, the pressure of the HOBr solution spray may be increased to further impinge the animal piece. Enhanced impingement allows the HOBr solution to penetrate the surface of the animal piece and attack embedded microorganisms.

The animal carcasses, animal trim, or animal offal are contacted with the HOBr solution for a time sufficient to effect a reduction in the number of human pathogenic bacteria associated with the animal pieces. Spraying may be accomplished in a dedicated cabinet in which an animal carcass is subject to a pressurized spray (between 25 and 250 psig) for less than one minute. Animal trim may be sprayed for less than five seconds with a low-pressure stream of HOBr solution from a spray bar as it moves along a conveyor belt. Most poultry processing facilities cool the product by submerging it for 30-180 minutes in a chiller tank containing an antimicrobial chemical. The chilled water solution is approximately 35° F.

### EXAMPLE 7

Some animal carcass washing facilities prefer to directly prepare the animal carcass wash (i.e., omitting the step of diluting a more concentrated solution). This example determined the optimum activation conditions in terms of the % conversion of Br⁻ ion into HOBr, the rate of the activation reaction, and the storage stability of the resultant activated solution.

Direct Preparation of Ready-to-Use (RTU) Carcass Wash

The relative stability of HOBr (expressed as Br₂) was compared at three different low concentrations. The HOBr (expressed as Br₂) concentrations compared were 600 ppm, 300 ppm, and 50 ppm. The solutions were activated separately by adding 1:1 stoichiometric amounts of HBr and NaOCl bleach to a known amount of city water to theoretically generate the desired concentrations, 600 ppm, 300 ppm, and 50 ppm of HOBr (expressed as Br₂). The calculated amounts are reported in Table 5. The 48% HBr was introduced to a known amount of city water. Using a magnetic stir plate the solution was mixed gently until homogenous. While mixing, a stoichiometric amount of sodium hypochlorite bleach of known activity (determined by the iodometric titration) was smoothly added to the solution. Any color transition was noted and the final pH was measured. The weights or volumes of reactants used to prepare the activated solutions are reported in Table 5.

The activated solutions were shielded from direct UV light to prevent photodegradation of HOBr during the stability testing. The tests were performed at ambient temperature. The solutions were initially tested using the DPD Differentiation Method (also known as the Palin Modification) to verify that no chlorine was present after activation. After confirming no excess chlorine was present, the solution was analyzed using the DPD Total Halogen Method. The results were expressed as ppm as bromine. These results were used to determine the percent bromide that was converted to HOBr. Decay profiles for each solution were used to determine the half-life and decay rate constant of the HOBr.

TABLE 5
Weights/Volumes Used for Preparation of NaOCl-Activated HBr Solutions

| HOBr Solution | City | | 48% | | |
|---|---|---|---|---|---|
| (Theoretical) | Water | | HBr | | Sodium Hypochlorite Bleach |
| 600 ppm as bromine | 900.0 | ml | 0.40 | ml | 1.9 ml Bleach 12.28% as Cl₂ |
| 300 ppm as bromine | 900.0 | ml | 0.20 | ml | 2.45 ml Bleach 11.64% as Cl₂ |
| 50 ppm as bromine | 3999.0 | g | 0.2295 | g | 0.7368 g Bleach 13.13% as Cl₂ |

Graphs of ln(Co/Ct) (where Co is the initial concentration of HOBr and Ct is the concentration at time t) were plotted against time t. All were close to straight lines (the regression analysis correlation coefficient, R² values were close to 1) for all three NaOCl-activated HBr solutions. The R² values for the 600 ppm, 300 ppm, and 50 ppm (expressed as Br₂) solutions were 0.9302, 0.8156, and 0.9352, respectively. From the lines, the half-life and decay rate constants were determined. The half-lives were calculated by dividing the slopes of the respective regression lines by 0.693—the natural logarithm of 2. The slope of the respective linear regression lines indicated the rate constant for HOBr decomposition (as Br₂) at each concentration. These figures are reported in Table 6.

TABLE 6
Summary of Decay Profiles

| | | | | Maximum % Br⁻ | | |
|---|---|---|---|---|---|---|
| | | | | Ion Activated | | |
| HOBr | | Conc. | | to HOBr | | |
| Solution | Color | (ppm as | pH (After | (time interval | Half- | Rate |
| (Theoretical) | Transition | Br₂) | Activation) | after activation) | Life | Constant |
| 600 ppm as | None - pale | 562.5 ppm | 7.51 | 87.73% (1 min) | 7.88 days* | 0.088 day⁻¹ |
| bromine | yellow | | | | | |
| | throughout | | | | | |
| | NaOCl | | | | | |
| | addition | | | | | |
| 300 ppm as | None - pale | 357.75 ppm | 7.27 | 100% (0.5 min) | 1837.8 min† | 0.0004 min⁻¹ |
| bromine | yellow | | | | (1.28 days) | |
| | throughout | | | | | |
| | NaOCl | | | | | |
| | addition | | | | | |
| 50 ppm as | None - pale | 48.15 ppm | 8.12 | 94.73% (5 min) | 680.4 min† | 0.001 min⁻¹ |
| bromine | yellow | | | | (0.47 day) | |
| | throughout | | | | | |
| | NaOCl | | | | | |
| | addition | | | | | |

*Stability of 600 ppm as bromine solution tracked once per day for 17 days
†Stability of 300 ppm and 50 ppm as bromine solutions tracked every 30 minutes for 3.5 hours

These solutions did not undergo any significantly visible color transitions during the activation of HBr. The endpoint was determined by calculating the stoichiometric amount of NaOCl bleach required to activate all the HBr. The equation below was used to determine the maximum percent of bromide converted to HOBr (expressed as Br₂).

$$\% {Br}^{-} Activated = \frac{\begin{matrix}Actual Concentration of HOBr \\ Recovered ( expressed as {Br}_{2} )\end{matrix} }{\begin{matrix}Theoretical Concentration of HOBr \\ Generated ( expressed as {Br}_{2} )\end{matrix}} \times 100$$

In Table 6 above, the time correlating to the maximum conversion of Br⁻ ion to HOBr is displayed in parentheses under its respective maximum percent-activated value. Based on this study, the lower boundary concentration was defined as HOBr (50 ppm as bromine). At this concentration, the half-life of the HOBr was adequate for storage up to one day, and the conversion of HBr to HOBr was still high (94.73%). Any lower concentration of HOBr than 50 ppm as bromine would be of little practical value to use in a meat or poultry plant engaged in sanitizing the animal carcasses, trim, and offal.

Indirect Preparation of Ready-to-Use (RTU) Carcass Washes from HOBr Solutions of Higher Concentration

When HBr is activated with sodium hypochlorite bleach the resultant hypobromous acid (HOBr) solution has long been considered by those knowledgeable in the art to be too unstable for practical commercial use (Howarth, U.S. Pat. Nos. 5,641,520 and 5,422,126). This example reports the decay constants and the half-life for two concentrations of HOBr. These were chosen to be above the lowest boundary condition of 50 ppm, and below the upper boundary condition of 30,000 ppm (as Br₂) (see example 12). The purpose of this study was to provide an indication of the persistency of hypobromous acid in the activated solution (expressed as Br₂). It also guides users of the time frame through which the NaOCl-activated HBr solutions may be used without appreciable decay. An additional objective of this example was to observe the change in pH of the activated HBr solutions over time.

A low and a high concentration of activated HBr solutions were employed in this study. The solutions were made by introducing sodium hypochlorite bleach to the HBr and city water until the color transition from dark orange to pale yellow was achieved, whereupon further addition of NaOCl was discontinued. Once the HBr solutions were activated, an initial pH and temperature were recorded and activity of HOBr was measured using the iodometric titration (results expressed as Br₂). The activated solutions were stored away from direct UV light to prevent photodegradation during the stability testing. The test was performed at ambient temperature. The activities of the solutions were tested periodically for 7-8 hours, along with recording the pH and temperature of each solution. The temperature ranged from 74-80° F. for all three studies.

The volumes used to prepare the high and low concentrations of HOBr are displayed in Table 7 below. Throughout this example, the low concentration HOBr solution (4800 ppm) is referred to as Solution 1 and the high concentration HOBr solution (8620 ppm) is referred to as Solution 2.

TABLE 7

| Low Concentration HOBr (4800 | High Concentration HOBr (8620 |
|---|---|
| ppm as Br₂) (Solution 1) | ppm as Br₂) (Solution 2) |
| 896.6 mL City Water | 844.4 mL City Water |
| 3.45 mL 48% HBr | 5.6 mL 48% HBr |

Hard city water was accurately measured out with a graduated cylinder. The HBr 48% was measured using a graduated pipette and added to the water. The solution was gently agitated before continuing. To activate the HBr, a known concentration of sodium hypochlorite bleach was added to the 48% HBr and water while gently mixing. The solution was initially colorless. As the sodium hypochlorite bleach was added, the color changed from colorless to bright yellow to a dark orange/red then to a pale yellow. The pale yellow indicated that further addition of NaOCl be discontinued. At this point, the pH of the activated solution should be close to neutral. The color of the solutions slowly regressed back to dark orange as time elapsed. The color regression occurred because of the instability of HOBr. After the HBr solution was activated with NaOCl, the time was recorded as zero minutes (T₀) and samples and readings were started.

### EXAMPLE 8

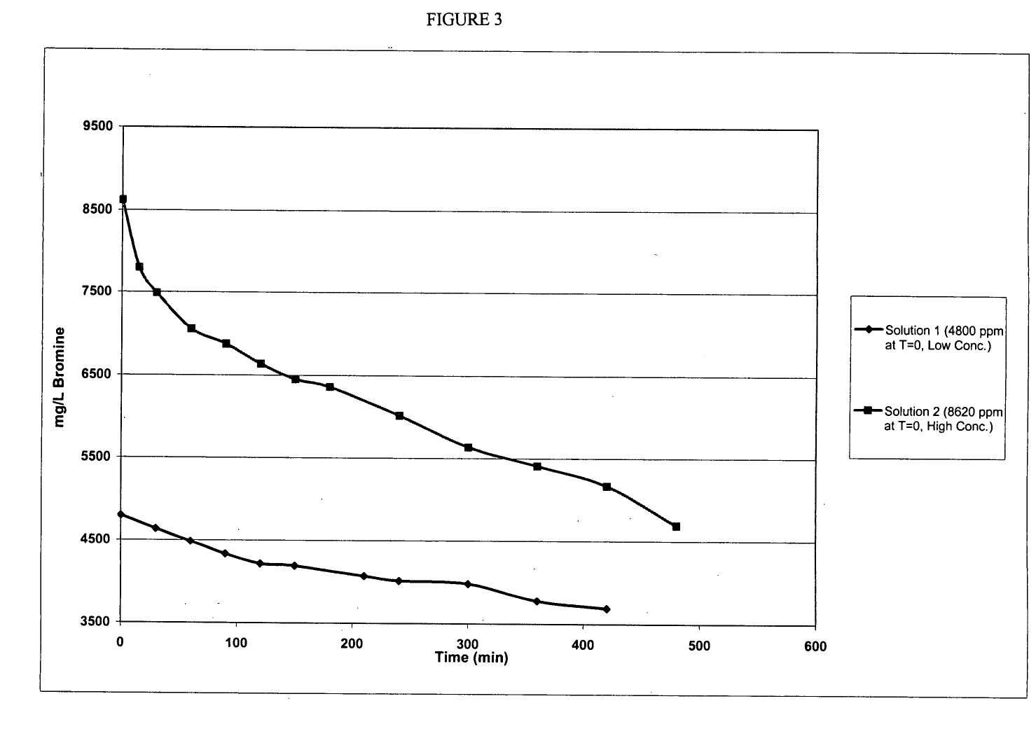

FIG. 3 illustrates the persistency of the HOBr (expressed as Br₂) for the low and high concentration solutions of activated HBr. Solution 1 (low concentration HOBr solution) utilized 3.45 mL of HBr 48% in 896.6 mL of city water and was activated with 19 mL of Bleach (9.29% as Cl₂). After the solution was activated, the activity tested at 4800 ppm as bromine, but due to the unstable nature of the HOBr, after seven hours the activity decayed to 3692 ppm as bromine. Solution 2 (high concentration HOBr solution) utilized 5.6 mL of HBr 48% in 844.4 mL of city water and was activated with 25 mL of bleach (12.5% as Cl₂). Initially the solution generated 8620 ppm as bromine, but due to the unstable nature of the HOBr, after eight hours the activity decayed to 4694 ppm as bromine.

The overview of the decay of HOBr with time provides users with a tentative means to determine the activity of the NaOCl-activated HBr solutions over time if the solution is not exposed to UV light. The half-life of each solution is reported in Table 8.

The pH of the NaOCl-activated HBr solutions is driven by the decay of HOBr. Therefore, the pH was observed while the HOBr decayed. Once HBr is activated with sodium hypochlorite, the pH is between 7 and 7.8. The pH drifts lower as HOBr decays according to the following equation:

2HOBr=O₂+2HBr

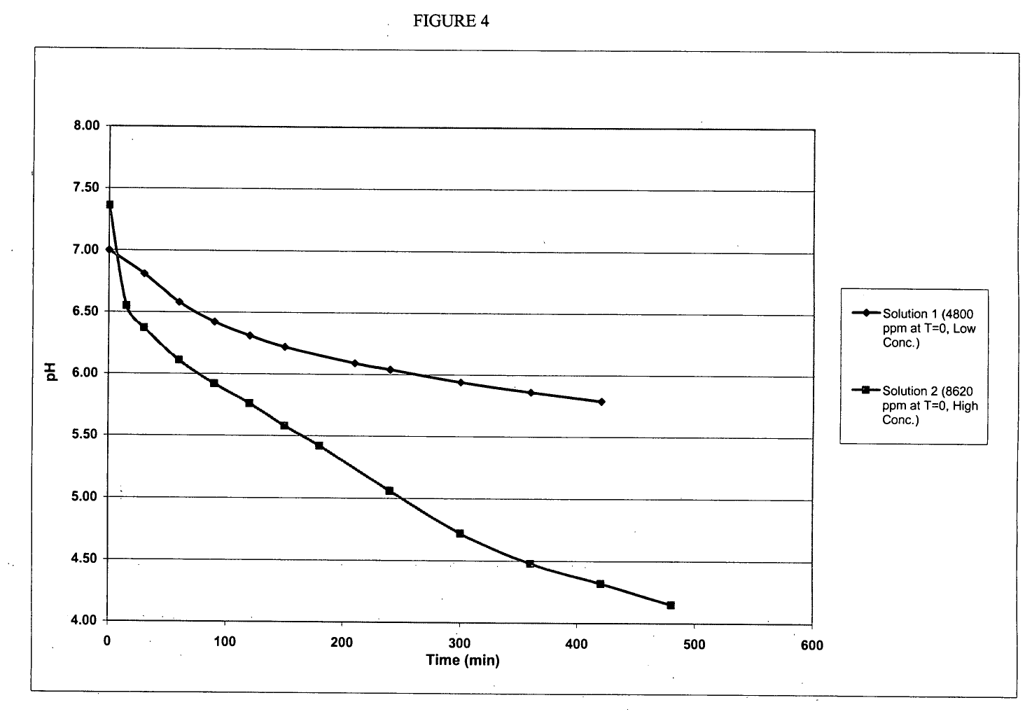

In FIG. 4, the pH was tracked over the time span of the study for both HOBr solutions. The initial pH of Solution 1, after activation, was 7.00 and after seven hours the pH dropped to 5.79. The initial pH of Solution 2, after activation, with sodium hypochlorite bleach was 7.36 and after eight hours the pH dropped to 4.15.

A graph of ln(Co/Ct) for the HOBr solutions (where Co is the initial concentration of HOBr and Ct is the concentration at time t) were plotted against time t. The plot was close to a straight line (the regression analysis correlation coefficients, R² values, were 0.9492 and 0.9357 for Solutions 1 and 2, respectively). From these lines, the half-lives and decay rate constants were determined. The half-lives were calculated by dividing the slope of the regression lines by 0.693—the natural logarithm of 2. The slope of the linear regression line indicated the rate constant for HOBr decomposition

The half-lives for the decay of HOBr (expressed as Br₂) in Solutions 1 and 2 (calculated by dividing the slopes of the respective regression lines by 0.692—the natural logarithm of 2) are displayed in Table 8 below. The half-lives are reported in minutes and hours. Solution 1 has approximately twice as long a half-life as Solution 2.

TABLE 8
Reported Half-lives

| | Half-Life of HOBr |
|---|---|
| Solution 1 | 1206 min (20 hrs) |
| (low concentration HOBr solution) | |
| Solution 2 | 656 min (11 hrs) |
| (high concentration HOBr solution) | |

The U.S. Food and Drug Agency (FDA) has approved the use of DBDMH solutions containing a maximum of 300 ppm as Br₂ for washing animal carcasses (Food Contact Notification, no. 792). It is therefore predicted that carcasses, trim, and offal washing or spraying with HOBr solutions prepared by the NaOCl-activated HBr solutions will require a maximum of 300 ppm as bromine. When activating a low or high concentrated solution of HOBr, as performed in this example, the solutions would need to be diluted accordingly (depending on the concentration of HOBr utilized, high or low concentration). The dilutions are to obtain a 300 ppm (expressed as Br₂) solution are displayed below in Table 9.

TABLE 9
Dilution factors

| Original Concentration | Dilution Factors (w/w) † |
|---|---|
| Solution 1 | Must dilute by a factor of 15.6 |
| (Low concentration HOBr solution) | |
| Solution 2 | Must dilute by a factor of 28.7 |
| (High concentration HOBr solution) | |

† The dilution can be accomplished with a proportional dispenser or with a separate diaphragm of centrifugal pump provided the volumetric flow rates of the dilution water and NaOCl-activated solution are known.

### EXAMPLE 9

The microbiological efficacy of the HOBr derived from NaOCl/HBr and the HOBr from DBDMH were compared against a culture of E. coli O157:H7 bacteria that was sprayed onto the surface of beef and pork meat.

Meat processing facilities commonly treat beef and pork with antimicrobial solutions for about 30 seconds by spraying the beef and pork carcasses and trim with the solution in a spray cabinet. To simulate this process, a small spray cabinet was constructed for the study. A 30-gallon, open-headed drum was equipped with three ½ inch PVC section of pipe that were vertically oriented and positioned 120 degrees apart. Each section of pipe had two spay nozzles four inches apart positioned to form a spray zone in the center of the drum. An air-assisted diaphragm pump was used to deliver the test solution into the three ½ inch PVC pipe sections and through the nozzles. A regulator on the air pump was used to adjust the pressure of the spray as necessary.

DBDMH granules manufactured by Albemarle Corporation were obtained from a local pool store. A saturated stock solution was made by mixing the product in water followed by gravity filtration to remove any undissolved solids. The stock solution was added to potable water in order to obtain the appropriate concentration.

A 48% solution of HBr was obtained from Chemtura Corporation. For this study, hypobromous acid (HOBr) was created on-site by combining solutions of hydrogen bromide and sodium hypochlorite.

A stock solution of a field strain of E. coli O157:H7 was incubated at 35° C. for four days in Sigma Nutrient Broth for microbial culture. Three daily, consecutive transfers of the inoculums were made to ensure that a sufficient concentration of E. coli O157:H7 was available for the study. The broth and bacteria mixture was then centrifuged leaving the E. coli O157:H7 to be re-suspended in approximately 500 ml Butterfield's Buffer. The E. coli O157:H7 buffer solution was serially diluted and plated on 3M Petrifilm E. coli plates, incubated at 35° C. for 48 hours where it was determined that the E. coli O157:H7 population was 6.76×10⁷ CFU/ml or log₁₀ 7.83.

The type of beef used was chuck roast, which was cut into nine equal pieces. The average weight of beef piece used in this portion of the study was 257.1 g. Nine boneless pork chops of average weight of pork 142.9 g were used.

Before spraying the meat, the concentration of HOBr in the respective solutions was measured using a Hach DPD Total Chlorine colorimeter, and the results expressed as ppm Br₂.

This study performed in triplicate, i.e., three pieces of each meat type was subjected to HOBr from NaOCl-activated HBr and from DBDMH for comparison with a city water control.

In summary:
Beef
   a) Control: Three beef pieces—city water
   b) DBDMH: Three beef pieces—288 ppm Br₂
   c) NaOCl/HBr: Three beef pieces—279 ppm Br₂
Pork
   a) Control: Three pork pieces—city water
   b) DBDMH: Three pork pieces—288 ppm Br₂
   c) NaOCl/HBr: Three pork pieces—279 ppm Br₂

During the 30 second spray, a piece of meat was held by a hook and moved up and down in the spray zone of the spray cabinet with rotation to ensure even distribution of the solution over the surface. The spray pressure was set at 50 psi.

Immediately after each piece was sprayed, a sample of the wash solution was taken from the bottom of the spray cabinet drum for microbial analysis. The solutions were plated on 3M Petrifilm E. coli plates and incubated at 35° C. for 48 hours.

After spraying, each meat piece was gently shaken three times to remove excess liquid and returned to a new, sterile bag containing 200 g of city water. The bag was sealed and then vigorously agitated manually for one minute to dislodge any viable surface-associated bacteria from the meat and into the aqueous phase. The water was then plated using 3M Petrifilm E. coli plates and incubated at 35° C. for 48 hours, after which the plates were enumerated. All plating for E. coli was performed within five minutes of completing the spray.

The microbiological quality of the wash waters is summarized in Table 10 where the two sources of HOBr are compared to that of a city water control.

TABLE 10

| | log10 | log10 |
|---|---|---|
| Description | (remaining) | reduction |
| Control Beef | 5.01 | N/A |
| DBDMH Beef | 0.48 | 4.53 |
| NaOCl/HBr Beef | 0.15 | 4.86 |
| Control Pork | 5.18 | N/A |
| DBDMH Pork | 0.99 | 4.19 |
| NaOCl/HBr Pork | 0.39 | 4.79 |

It can be seen that both DBDMH and NaOCl-activated HBr treatments afford good reductions of bacteria present in the wash water. However, the NaOCl-activated HBr displays a measurably higher efficacy than DBDMH.

The average concentrations of viable E. coli O157:H7 bacteria remaining on both the beef and the pork after being sprayed with the different sources of HOBr is compared to the amount remaining for just a spray with city water in Table 11.

TABLE 11
Reduction in the Number of Surface-Associated Bacteria
Remaining on the Meat after Spraying the Pieces with
Solutions of HOBr from DBDMH and NaOCl/HBr

| | log10 | log10 | |
|---|---|---|---|
| Description | (remaining) | reduction | % reduction |
| Control Beef | 6.15 | — | — |
| DBDMH Beef | 5.56 | 0.59 | 74.30 |
| NaOCl/HBr Beef | 5.45 | 0.70 | 80.03 |
| Control Pork | 6.43 | — | — |
| DBDMH Pork | 5.71 | 0.72 | 80.95 |
| NaOCl/HBrPork | 5.25 | 1.18 | 93.39 |

The same trend is apparent as was seen in the wash water; both DBDMH and NaOCl-activated HBr treatments afford good reductions in the number of surface-associated bacteria. However, the NaOCl-activated HBr displays a measurably higher efficacy than DBDMH on both beef and pork.

### EXAMPLE 10

In the processing of poultry, birds that are deemed by the USDA inspectors to have undesirable levels of fecal contamination are directed to a dedicated cabinet where they are sprayed with an antimicrobial solution. If the fecal contamination were not removed, birds harboring the pathogenic Salmonella organism would enter the human food chain. Therefore, the microbiological efficacy of the HOBr derived from NaOCl/HBr and the HOBr from DBDMH were compared on chicken inoculated with a culture of Salmonella typhimurium (ATCC 14028) bacteria.

DBDMH granules manufactured by Albemarle Corporation were obtained from a local pool store. A saturated stock solution was made by mixing the product in water followed by gravity filtration to remove any undissolved solids. The stock solution was added to potable water in order to obtain the appropriate concentration.

A 48% solution of HBr was obtained from Chemtura Corporation. For this study, hypobromous acid was created on-site by combining hydrogen bromide and sodium hypochlorite.

A stock solution of Salmonella typhimurium (ATCC 14028) was incubated at 35° C. for four days in Sigma Nutrient Broth for microbial culture. Three daily, consecutive transfers of the inoculums were made to ensure that a sufficient concentration of Salmonella typhimurium was available for the study. The broth and bacteria mixture was then centrifuged leaving the Salmonella typhimurium to be re-suspended in approximately 500 ml Butterfield's Buffer. The Salmonella buffer solution was serially diluted and plated on 3M Petrifilm Enterobacteriaceae Plates, incubated at 35° C. for 24 hours where it was determined that the Salmonella typhimurium population was 2.34×10⁸ or log₀ 8.37 CFU/ml (colony forming units per milliliter).

Three whole, uncooked chickens were purchased from a local grocer. The average weight of the whole chickens was 5.30 pounds. The organs were removed from each chicken and subsequently, each chicken was cut evenly in half down the back leaving six equal halves which contained a back, breast, thigh and leg. The chicken halves were then patted dry with a paper towel, sprayed liberally on all sides and marinated with Salmonella typhimurium-Butterfield's Buffer solution inoculums for two hours, turning occasionally.

The six chicken pieces were introduced to the spray cabinet used in Example 9. This study was performed in duplicate, i.e., two chicken halves were subjected to each test substance for 30 seconds. During the 30 second spray, a chicken half was held by a hook and moved up and down while rotating to ensure even distribution of the test spray at 40 psi. The concentration of HOBr was measured prior to spraying the meat pieces by using a HACH DR/700 Colorimeter and HACH 10 ml DPD Total Chlorine pillow packets.

In summary:
a) Control: Two chicken halves—city water
b) DBDMH: Two chicken halves—295 ppm as total bromine
c) NaOCl/HBr: Two chicken halves—275 ppm as total bromine

After spraying, the chicken half was gently shaken three times to remove excess liquid and returned to a new, sterile bag and taken to the lab. 300 g of sterile city water was introduced to the bag and the bag was vigorously shaken for one minute to dislodge viable surface-associated Salmonella bacteria remaining on the chicken half. This water was plated using 3M Petrifilm Enterobacteriaceae Plates and incubated at 35° C. for 24 hours, upon which the plates were enumerated. All plating for Salmonella was performed within 10 minutes of completing the spray.

Table 12 reports the average number of bacteria left on the food after being sprayed for 30 seconds with each challenge solution: city water (control), DBDMH, NaOCl-activated HBr. It can be seen that the control averaged a log₁₀ of 6.15 CFU/ml. The chicken sprayed with the DBDMH solution had a log₁₀ reduction in Salmonella typhimurium bacteria of 0.30 CFU/ml (49.88%). There was a log₁₀ reduction of 0.34 CFU/ml (54.29%) when the chicken was sprayed with NaOCl-activated HBr.

TABLE 12
Reduction in the Number of Surface-Associated Bacteria
Remaining on the Poultry after Spraying the Pieces
with Solutions of HOBr from DBDMH and NaOCl/HBr

| | log10 | log10 | |
|---|---|---|---|
| Description | (remaining) | reduction | % reduction |
| Control Chicken | 6.15 | N/A | N/A |
| DBDMH Chicken | 5.85 | 0.30 | 49.88 |
| NaOCl/HBr Chicken | 5.81 | 0.34 | 54.29 |

The same trend is apparent for chicken inoculated with Salmonella typhimurium bacteria as was seen for beef and pork inoculated with E. coli O157:H7 bacteria; although both DBDMH and NaOCl/HBr treatments afford good reductions in the number of surface-associated bacteria, the NaOCl-activated HBr treatment displays a measurably higher efficacy than DBDMH.

### EXAMPLE 11

Most poultry processing facilities cool the product by submerging it for 30-60 minutes in a chiller tank containing an antimicrobial chemical. The chilled water solution is typically around 35° F. (Food Contact Notification, nos. 334 and 453). Therefore, the microbiological efficacy of the HOBr derived from NaOCl-activated HBr and the HOBr from DBDMH were compared by immersing chickens inoculated with a culture of Salmonella typhimurium (ATCC 14028) bacteria. An inoculum was prepared in the same manner as described in Example 10. This time the inoculum yielded a Salmonella typhimurium population of 3.78×10⁸ CFU/ml, or log₁₀ 8.58. This was then sprayed onto both sides of the chicken halves and left to marinate for two hours. The average weight of the whole chicken used in this portion of the study was 5.20 lbs.

Each test solution was made with chilled water immediately prior to use. For each test solution and the control, two chicken halves were placed in a plastic storage bin containing one quart of test solution. A sterilized ice pack was placed in the bin to accompany the chicken and maintain water temperature. The chicken halves were allowed to sit in the chilled solution for 40 minutes at 35° F., and were turned every five minutes while gently agitating the storage bin. All containers were covered using aluminum foil to prevent degradation of the active ingredients by UV light.

In summary:
a) Control: Two chicken halves—city water
b) DBDMH: Two chicken halves—95 ppm as total bromine
c) NaOCl/HBr: Two chicken halves—100 ppm as total bromine

After spraying, each chicken half was gently shaken three times to remove excess liquid and returned to a new, sterile bag. 300 g of city water was introduced to the bag and the bag was tumbled vigorously for one minute to dislodge viable surface-associated Salmonella bacteria. The water left at the bottom of the bag was plated using 3M Petrifilm Enterobacteriaceae Plates and incubated at 35° C. for 24 hours, upon which the plates were enumerated.

Table 13 contains the average number of bacteria left on the food after the 40 minute challenge test with each solution: city water (control), DBDMH, and the NaOCl/HBr solutions. It can be seen that the control averaged a log₁₀ of 6.54 CFU/ml. The chicken submerged in the DBDMH solution had a log₁₀ reduction in Salmonella typhimurium bacteria of 0.29 CFU/ml (48.71%). The chicken submerged in the NaOCl-activated HBr solution had a log₁₀ reduction of 0.50 CFU/ml (68.38%).

TABLE 13
Reduction in the Number of Surface-Associated Bacteria Remaining
on the Chicken after Immersion for 40 Minutes in Solutions
of HOBr from DBDMH and NaOCl-activated HBr.

| | log10 | log10 | |
|---|---|---|---|
| Description | (remaining) | reduction | % reduction |
| Control Chicken | 6.54 | N/A | N/A |
| DBDMH Chicken | 6.25 | 0.29 | 48.71 |
| NaOCl/HBr Chicken | 6.04 | 0.50 | 68.38 |

For the immersed Salmonella typhimurium inoculated chicken, the same trend is apparent as was for chicken that were sprayed; although DBDMH and NaOCl/HBr treatments both afford good reductions in the number of surface-associated bacteria, the NaOCl-activated HBr treatment displays a measurably higher efficacy than DBDMH.

V. Compositions of HOBr

A third embodiment of the invention is a composition made by the method of the first embodiment in which the concentration of HOBr is greater than 20,000 ppm and less than 40,000 ppm (as Br₂).

For efficient water management reasons, some animal carcass washing facilities may elect not to prepare an RTU solution directly from HBr and NaOCl bleach as described above. Instead they may wish to prepare a concentrated product to be stored at a central point in the plant, then dilute the product to several different concentrations to be used at different Points-Of-Use (POU) areas of the facility (e.g., different concentrations of HOBr may be required at the carcass wash, trim tables, chiller tanks, on-line processing (OLR), off-line processing, inside-outside bird washes (IOBW), the “hot box” spray where beef and pork carcasses are hung for up to two days to bring their temperature down, and incorporated into ice that animal carcasses or animal carcass trim may come in contact with. Having a central storage point from which the different concentrations of HOBr are prepared by dilution to the required concentration represents a large convenience for the facility.

For these highly concentrated solutions of HOBr, it was therefore considered necessary to define the optimum activation conditions in terms of the % conversion of Br⁻ ion into HOBr, the rate of the activation reaction, and the storage stability of the resultant concentrated activated solutions.

There are limits as to how concentrated a solution of activated HBr can be made. Safety is one factor that would limit the concentration of activated HBr. The activated solution would need to be prepared and stored in a facility without releasing toxic bromine gas into the atmosphere. Second to safety is the efficiency of conversion of the bromide ions to HOBr, as this represents the major chemical cost and hence the economics of the process. A desired process needs to have a relatively high conversion of Br⁻ ion into HOBr in order for the solution to be economically practical. Therefore, the necessary boundary conditions were determined for the use of HBr at the highest possible limit. The boundaries set were determined from the data collected from studies on HBr solutions of different concentrations that had been activated with a sodium hypochlorite solution. This example defines the highest boundary limit (which still has practical use in meat and poultry processing facilities) for a HOBr concentrate that would be diluted down to any desired concentration without posing a hazard.

### EXAMPLE 12

Indirect Preparation of Ready-to-Use (RTU) Carcass Washes from Concentrated Solutions

The relative stability of HOBr (expressed as Br₂) was compared at three different high concentrations. The theoretical HOBr (expressed as Br₂) concentrations compared were 20,000 ppm, 30,000 ppm, and 40,000 ppm (expressed as Br₂). The solutions were activated separately by adding a stoichiometric amount of 48% HBr and sodium hypochlorite bleach (of known concentration expressed as % Cl₂) to a known amount of city water to theoretically generate the desired concentrations of 20,000 ppm, 30,000 ppm, and 40,000 ppm (expressed as Br₂). The HBr 48% was introduced to the known amount of city water first. Using a magnetic stir plate, the solution was mixed gently until homogenous. While mixing, a stoichiometric amount of sodium hypochlorite bleach of known activity (determined by the iodometric titration) was smoothly added to the solution. Any color transition was noted and the final pH was measured.

The first concentration attempted was 40,000 ppm (expressed as bromine). To activate this solution, city water (741.0 g) was weighed into a liter beaker to which 48% HBr (38.04 g) was added. While mixing, sodium hypochlorite bleach (13.24% expressed as Cl₂) (120.96 g) was smoothly added. This study was terminated after the bleach was added due to the large amounts of toxic bromine gas released from solution and into the atmosphere (fumes visible above surface of the solution). The pH did not go higher than 6.45 and no color transition occurred (final color was dark orange/red, not a bright yellow). The fact that the solution did not turn bright yellow and that the pH did not exceed 7.0 indicated that the HOBr decomposed too quickly to be of practical use, and that it would be too unsafe to store in any facility due to the toxic bromine gas released from solution and into the atmosphere.

The second concentration activated was a 20,000 ppm (expressed as bromine) solution of NaOCl-activated HBr. City water (820.5 g) was weighed into a liter beaker, to which 48% HBr (19.02 g) was added. When the sodium hypochlorite bleach (13.24% expressed as Cl₂), (72.31 g) was added, the color transitioned to dark orange and then back to a bright yellow indicative of activation. No bromine fumes were released, so the decay profile was tracked. The activated solution was stored away from direct UV light to prevent photodegradation during the testing. The test was performed at ambient temperature. The solution was initially tested using the DPD Differentiation Method (also known as the Palin Modification) to confirm no chlorine was present after activation. After proving no excess chlorine was present, the solution was analyzed using the iodometric titration. The results were expressed as ppm as bromine. The results were used to determine the percent bromide activated. Tracking the decay profile of the activated solution followed this.

A graph of ln(Co/Ct) for the 20,000 ppm solution (where Co is the initial concentration of HOBr and Ct is the concentration at time t) was plotted against time t. The plot was close to a straight line (the regression analysis correlation coefficient, R² value was 0.9850). From this line, the half-life and decay rate constant were determined. The half-life was calculated by dividing the slope of the regression line by 0.693—the natural logarithm of 2. The slope of the linear regression line indicated the rate constant for HOBr decomposition.

The third concentration tested was 30,000 ppm as bromine. City water (1039.4 g) was weighed out in a liter beaker, to which 48% HBr (38.02 g) was added. When the sodium hypochlorite bleach (13.07% expressed as Cl₂) (122.54 g) was added the color transitioned to dark orange and then back to a bright yellow and no bromine fumes were released at first. The activated solution was stored away from direct UV light to prevent photodegradation during the stability testing. The test was performed at ambient temperature. The solution was only initially tested using the DPD Differentiation Method (also known as the Palin Modification) to confirm there was no chlorine present after activation. Approximately 1 minute after activating the solution, bromine gas started to be released from the solution as the HOBr decomposed. The sample was tested 0.5 minutes after activation and the activity had already been compromised by the rapid decay of the HOBr, therefore the decay rate was too fast to track the decay profile so half-life and decay rate constant data were unable to be measured. The figures for the three high concentrations are summarized in Table 14 below.

TABLE 14
Summary of Decay Profiles

| NaOCl- | | | | | | |
|---|---|---|---|---|---|---|
| activated | | | | | | |
| HBr Solution | Color | Conc. | pH (After | % Br₂ | Half- | Rate |
| (Theoretical) | Transition | (ppm as Br₂) | Activation) | Activated | Life | Constant |
| 40,000 ppm | Dark | NM | 6.45 | NM | NM | NM |
| as bromine | Orange/Red | | | | | |
| | throughout | | | | | |
| 20,000 ppm | Dark | 18,472 ppm | 6.75 | 92.19% | 135 min | 0.0051 min⁻¹ |
| as bromine | Orange to | | | (1 min) | | |
| | Bright | | | | | |
| | Yellow | | | | | |
| 30,000 ppm | Dark | 22,674 ppm | 6.62 | 75.49% | NM | NM |
| as bromine | Orange to | | | (0.5 min) | | |
| | Bright | | | | | |
| | Yellow | | | | | |

NM = Not measured

In Table 14 above, the time correlating to the highest conversion of bromide ion to HOBr (reported as Br₂) is displayed in parentheses under its respective percent-activated value. Based on the practicality of the concentrations used in this study, the higher boundary was defined as 30,000 ppm as bromine. At this concentration the half-life of the HOBr was too short to be measure, but the conversion of HBr to HOBr was still adequate (75.49%) to engineer around issues connected with controlling the release of bromine fumes into the atmosphere, and allow time for the solution to be diluted to a final use-concentration. Levels of HOBr higher than 40,000 ppm would be would be of little practical value at a meat or poultry plant engaged in sanitizing the animal carcasses, trim and offal because of the inability to measure a meaningful % Br⁻ ion conversion to HOBr due to its rapid decomposition. Poor conversion of bromide ions to HOBr is undesirable as this represents the major chemical cost and hence the economics of the process.

When generating and storing a concentrated solution, similar to the concentrations presented in this example, diluting to the use-concentration is required. To make the concentrated solution to the desired 300 ppm as bromine to spray or soak animal carcasses, trim and offal, the concentrate activated solutions would need to be diluted accordingly. Table 15 provides the dilution factors that would be used to dilute a theoretical 20,000 ppm and 30,000 ppm (expressed as Br₂) activated solution of HBr to give a solution of 300 ppm (expressed as Br₂). These dilutions can be easily produced by either using a pump to deliver the appropriate amount of activated solution to a known flow rate of dilution water, or to use a dosing apparatus similar to that in FIG. 1.

TABLE 15
Dilution Ratio to achieve 300 ppm (expressed as bromine)

| NaOCl-activated HBrSolution | |
|---|---|
| (Theoretical) | Dilution Factors † (w/w) |
| 20,000 ppm as bromine | Dilute by a factor of 62 |
| 30,000 ppm as bromine | Dilute by a factor of 76 |

† The dilution can be accomplished with a proportional dispenser or with a separate diaphragm of centrifugal pump provided the volumetric flow rates of the dilution water and NaOCl-activated solution are known.

VI. Method of Reducing Fat, Oil, and Grease

Another embodiment of the invention is a method of reducing the build-up of fat, oil, and grease on food contact and equipment surfaces, and hard surfaces, such as floors, used in the processing of animal carcasses, trim, and offal.

During the processing of animal carcasses, the meat products move between the various processing stations via conveyor belts. Over the course of a shift, layers of fat, oil, and grease can accumulate on the belts, as well as on other equipment, and the floor. On floors these layers represent a slipping hazard to employees whereas on food contact surfaces the layers represent a safe harbor for potentially dangerous microorganisms. Therefore, at the end of a shift, the equipment is chemically cleaned of the layers of fat, oil, and grease to ready it for the next shift. Fat is removed by saponification using highly alkaline chemicals which can be expensive and hazardous. Oil and grease are removed by emulsification with synthetic surfactants.

The antimicrobial solutions prepared by the method of the current invention are near pH neutral, and contain no surfactants. Nevertheless, these solutions have been found to exhibit surprising and remarkable fat, oil, and grease solubilization properties. Not only do these solutions have the advantages of reducing cleaning chemicals and clean-up times, they are also effective against microorganisms concomitant in the fat, oil and grease layers that accumulate on equipment, such as conveyor belts, and other food contact surfaces, and on other hard surfaces, such as floors.

One method of use in a meat or poultry plant during production cycles that would be advantageous would be to use a continuous dip tank or water spray containing the HOBr solution, which would help solubilize and reduce the buildup of fats and oils on conveyor belts and equipment which can harbor pathogenic microorganisms. A second benefit of this method would be to decrease the cleaning time and chemicals used between production shifts due to less contamination and microorganisms remaining on the equipment during production periods.

In order to quantify the lipophilicity of HOBr solutions prepared from NaOCl-activated HBr, the Octanol-Water Partition Coefficient was determined. Further, since the HOBr from DBDMH is closely associated with the organic DMH molecule which contains three carbon atoms, it was expected that these solutions would exhibit even greater lipohilicity for superior fat, oil and grease solubilization properties.

The Octanol-Water Partition Coefficient is defined as:

$${P}_{ow} = \frac{{C}_{octanol}}{{C}_{water}}$$

Where:

P_{ow}=Octanol-Water Partition Coefficient. Commonly the logarithm of this number is reported as Log P_{ow}

C_{octanol}=Concentration of solute in the octanol layer

C_{water}=Concentration of solute in the water layer

### EXAMPLE 13

A high concentration of a HOBr solution was prepared by introducing sufficient NaOCl to activate 3.34 ml 48% HBr in 900 ml RO water until the pH was 7.23. By iodometric titration, the solution was determined to contain 5625 ppm as Br₂. The slightly yellow activated solution (25 ml) was poured into an Erlenmeyer flask containing octanol (25 ml). This was mixed for two minutes using a high-speed magnetic stirrer after which the two phases were allowed to separate. All of the yellow color had phase-separated into the top octanol layer. Serial dilution followed by use of the DPD total chlorine colorimetric method titration of the aqueous phase revealed it to contain only 59.6 ppm as Br₂. The P_{ow} was calculated to be 1.97. This was repeated for lower concentrations of HOBr by preparing a stock solution of 300 ppm as Br₂ using 0.2 ml 48% HBr in 900 ml RO water and adding sufficient NaOCl bleach until the pH was 7.33. From the 300 ppm as Br₂ stock solution, solutions of 200 and 100 ppm as Br₂ were prepared.

Further octanol-water partition coefficient testing was performed exactly as before. Table 16 summarizes the results.

TABLE 16

| | Concentration in | | | |
|---|---|---|---|---|
| | aqueous phase | | | |
| | after partitioning | P_{ow} HOBr | % HOBr remaining | |
| Concentration | into octanol/ | form NaOCl- | Aqueous | Octanol |
| HOBr (as Br₂) | ppm as Br₂ | activated HBr | Phase | Phase |
| 5625 | 59.6 | 1.970 | 1.06 | 98.94 |
| 300 | 2.59 | 1.976 | 1.05 | 98.95 |
| 200 | 2.59 | 1.911 | 1.21 | 98.79 |
| 100 | 1.46 | 1.871 | 1.33 | 98.67 |

A saturated solution of DBDMH was prepared by slurrying DBDMH (1 g) powder in RO water (99 g) and stirring rapidly for 20 minutes. Undissolved solids were removed by gravity filtration. By iodometric titration, the solution was determined to contain 1170 ppm as Br₂. The DBDMH solution (25 ml) was poured into an Erlenmeyer flask containing octanol (25 ml). This was mixed for two minutes using a high-speed magnetic stirrer after which the two phases were allowed to separate. Serial dilution followed by use of the DPD total chlorine colorimetric method of the aqueous (bottom) phase revealed it to contain only 159.7 ppm as Br₂. The P_{ow} was calculated to be 0.808. The 1170 ppm as Br₂ stock solution was then used to prepare solution of 300, 200 and 100 ppm as Br₂ solutions.

Further octanol-water partition coefficient testing was performed exactly as before. Table 17 summarizes the results.

TABLE 17

| | Concentration in | | | |
|---|---|---|---|---|
| | aqueous phase | | | |
| | after partitioning | P_{ow} HOBr | % HOBr remaining | |
| Concentration | into octanol/ | from | Aqueous | Octanol |
| HOBr (as Br₂) | ppm as Br₂ | DBDMH | Phase | Phase |
| 1170 | 157.5 | 0.808 | 13.46 | 86.54 |
| 300 | 50.74 | 0.731 | 15.66 | 84.34 |
| 200 | 34.99 | 0.719 | 16.03 | 83.97 |
| 100 | 19.125 | 0.645 | 18.48 | 81.52 |

Comparing the data in Table 16 with that in Table 17 indicates that the HOBr from NaOCl-activated HBr exhibits far more lipophilicity than the HOBr from DBDMH. This is a surprising discovery because the HOBr from DBDMH is closely associated with the organic DMH molecule, which contains five carbon atoms and would be expected to partition into the organic octanol phase to a greater extent than the HOBr from the totally inorganic NaOCl and HBr sources. Thus, the enhanced lipophilicity of HOBr from NaOCl/HBr compared to HOBr from DBDMH affords the former with remarkably superior fat, oil and grease solubilization properties in meat and poultry processing environments.

### EXAMPLE 14

The stability of the HOBr from NaOCl-activated HBr source that partitioned into the octanol phase was determined.

A stock solution of HOBr was prepared by adding 48% HBr (3.45 ml) to RO water (900 ml). Industrial-grade sodium hypochlorite (about 20 ml) was added until the pH of the solution was 7.26. Iodometric titration revealed the HOBr solution to be 3487 ppm as Br₂. This solution was designated the high concentration of HOBr. An aliquot (42 g) of this solution was made up to 500 ml with RO water. This solution was designated the low concentration of HOBr.

To each of the above solutions (200 ml), octanol (200 ml) was added. The aqueous and the non-aqueous layers were vigorously mixed with a magnetic stirrer whereupon the layers were allowed to phase separate. The stability of the HOBr that had partitioned into the octanol phase was assessed using a non-aqueous iodometric titration. In this technique, an aliquot of the respective octanol phases was added to an aqueous phase containing acetic acid and potassium iodide. With intense mixing of the two phases, using the oxidation of iodide to iodine as the driving force to partition the HOBr out of the octanol and into the aqueous phase, the mixture was slowly titrated with 0.100 N sodium thiosulfate as a 1% starch solution was introduced to sharpen the blue-to-clear end-point.

Non-aqueous iodometric titrations were performed for each solution of HOBr partitioned into octanol. The results are summarized in Table 18.

TABLE 18

| | High Concentration of HOBr | Low Concentration of HOBr |
|---|---|---|
| Time/min | in Octanol/ppm as Br₂ | in Octanol/ppm as Br₂ |
| 0 | 3541 | 384 |
| 30 | 1402 | 172 |
| 60 | 1030 | 92 |
| 90 | 800 | 85 |
| 170 | 469 | 0 |

It can be seen that for both high and low concentration of octanol-partitioned HOBr, the HOBr is unstable and decomposes over the course of 170 minutes. The HOBr is evidently decomposing due to its oxidation of the hydroxyl group of octanol. Similar oxidation reactions would occur when HOBr partitions into fats, oils and greases in meat and poultry processing environments. This explains the remarkable fat, oil, and grease solubilization properties that solutions of HOBr from NaOCl-activated HBr have been discovered to possess.

We claim:

1. A method for preparing an aqueous solution of hypobromous acid, comprising:
a.) mixing an aqueous solution of hydrogen bromide and a source of hypochlorite with water to form hypobromous acid;
b.) wherein the amounts of said hydrogen bromide solution and said source of hypochlorite are in an approximately 1:1 stoichiometric ratio such that each mole of hydrogen bromide is mixed with approximately one mole of hypochlorite ion from said source of hypochlorite, and further;
c.) wherein said preparation of hypobromous acid is a continuous or intermittent process.

2. The method of claim 1, wherein said aqueous solution of hydrogen bromide is obtained from mixing a solution of sodium bromide with a strong mineral acid.

3. The method of claim 2, wherein said strong mineral acid is selected from the group consisting of hydrochloric acid, sulfuric acid, and nitric acid.

4. The method of claim 1, wherein the source of hypochlorite is an aqueous solution selected from the group consisting of sodium hypochlorite, potassium hypochlorite, and calcium hypochlorite.

5. The method of claim 1, wherein said aqueous solution of hydrogen bromide and said source of hypochlorite are added sequentially to said water.

6. The method of claim 1, wherein said aqueous solution of hydrogen bromide and said source of hypochlorite are added simultaneously to said water.

7. A method of using the hypobromous acid prepared by the method of claim 1 to reduce microorganisms on and in an animal carcass, animal trim, or animal offal, comprising contacting an animal carcass, animal trim, or animal offal with the hypobromous acid for at least five seconds with 50-30,000 ppm as bromine.

8. The method of claim 7, wherein said contacting is accomplished by dipping, submerging, spraying, or fogging the animal carcass, trim, or offal with said hypobromous acid.

9. An aqueous solution of hypobromous acid prepared by the method of claim 1.

10. The aqueous solution of hypobromous acid of claim 10, wherein the concentration of said aqueous solution is between 20,000 ppm and 30,000 ppm as bromine.

11. A method of using the hypobromous acid prepared by the method of claim 1 to reduce the build-up of fat, oil, and grease on food contact surfaces, equipment, floors, and other hard surfaces used in the processing of animal carcasses, animal trim, and animal fat, comprising treating the food contact surfaces, equipment, floors, or other hard surfaces with the hypobromous acid.

12. The method of claim 11, wherein the concentration of said hypobromous acid is 50-30,000 ppm as bromine.
